(19) United States
(12) Patent Application Publication
(10) Pub. No.: US 2026/0289676 A1
(43) Pub. Date: Sep. 24, 2026

(54) SYSTEM AND METHOD FOR CONNECTING INDIVIDUALS OFFERING AND SEEKING INVESTMENT OPPORTUNITIES

(71) Applicants: Joanna NELL, Arundel (AU); Glen TOWSE, Arundel (AU)

(72) Inventors: Joanna NELL, Arundel (AU); Glen TOWSE, Arundel (AU)

(21) Appl. No.: 19/698,533

(22) Filed: Jun. 4, 2026

Related U.S. Application Data
(63) Continuation of application No. 18/708,465, filed on Nov. 4, 2022.

(30) Foreign Application Priority Data
Nov. 8, 2021 (AU) 2021903557

(51) Int. Cl. G06Q 40/06

(52) U.S. Cl. CPC G06Q 40/06

(57) ABSTRACT

A connection is facilitated between a user having investment opportunities and potential investors to enable communication therebetween. Details from the user seeking to register their investment opportunity are received and recorded. The details include a description of the goods/services provided/to be provided by a business associated with the investment opportunity, thereby creating an investment opportunity profile. Information from each of the potential investors are received and recorded and based thereon, whether each of the potential investors meets one or more predefined criteria is verified, thereby confirming whether each potential investor has the necessary bona fides to represent their interest in an investment opportunity of the registered investment opportunities. A list of verified potential investor profiles are generated, and the investment opportunity profile of each user is compared with each verified potential investor profile to establish matches between investment opportunities of the investment opportunities and one of the potential investors.

### CROSS REFERENCE RELATED APPLICATIONS

The present application is a Continuation of U.S. patent application Ser. No. 18/708,465 filed May 8, 2024, which is a National Stage of International Application No. PCT/AU2022/051326 filed Nov. 4, 2022, which claims priority to Australian Patent Application No. 2021903557 filed Nov. 8, 2021, the disclosure of which are incorporated by reference in their entireties.

### FIELD OF THE INVENTION

The present invention relates to a system and method for individuals seeking investment funds (founders) and individuals seeking investment opportunities (investors) and facilitating connection therebetween with an increased level of confidence that each party is a trusted representative and has the necessary bona fides to enter in an investment agreement.

### BACKGROUND OF THE INVENTION

Whether an individual is an entrepreneur, a startup or an established business owner, the ability to effectively raise capital regularly means the difference between success and failure. There are various methods for raising capital for a startup or business venture including, but not limited to, using personal funds, obtaining a business loan, crowd funding, relying on personal contacts, or relying upon external investors (for example, Angel Investors and Venture Capitalists).

Although the use of an individual's personal funds is the easiest means to raise capital for a startup or business venture, personally funding a business carries significant risk for individuals. Moreover, many individuals either do not have the funds required to adequately fund a business venture, or fail to accurately estimate the capital required to adequately fund a business venture thereby increasing the risk of failure.

As an alternative to personally funding a business venture, many individuals elect to apply for a small business loan when deciding to launch a new business. However, there is no guarantee that a loan application will be approved with the applicant needing to establish that they meet specific requirements including adequate credit history and past business experience. Additionally, similar to personally funding a business venture, small business loans also carry significant risk for individuals.

Crowdfunding has recently been gaining increased attention as a capital raising strategy which involves raising small amounts of money from a large number of people. However, successful crowdfunding campaigns require a significant amount of time and effort and only a fraction of crowdfunding campaigns meet their desired goals.

Another common method of raising capital for a business venture relies upon seeking a loan or investment funds from family members and friends. However, many individuals do not feel comfortable approaching family members and friends for money to fund a business venture. Moreover, such arrangements between family and friends often add more stress to the funding process and also carry significant risk, not only from a financial perspective, but from a personal and emotional perspective. Accordingly, such arrangements are generally not advised.

Two types of external investors are Angel Investors and Venture Capitalists. Angel Investors are typically wealthy individuals who usually fund businesses alone, but sometimes join other Angel Investors to fund a business venture. In comparison, Venture Capitalists tend to invest in more mature companies as compared with Angel Investors, and tend to operate as a business representing many investors who have entrusted their funds to the Venture Capitalist. As compared with Angel Investors, Venture Capitalists tend to invest in fewer businesses, but when they do invest, tend to invest larger amounts of money. However, an issue with both Angel Investors and Venture Capitalists is the difficulty in establishing a connection with same, and hence, many individuals with an investment opportunity experience difficulty, or discover that the process of raising capital from external investors, is very time consuming and inefficient.

Another problem associated with investment transactions is that individuals with prior experience and who have established professional networks tend to have an advantage in establishing a rapport with the other transacting party whereas individuals without any prior experience or established networks experience difficulty establishing their credibility. Accordingly, investment transactions are not always performed in environments that provide the same opportunities to both experienced and inexperienced founders and investors, and those individuals who have the most experience and established professional networks typically achieve greater success as compared with their more inexperienced counterparts. This problem is typically exacerbated when investment transactions are conducted in an online environment.

The internet has provided a number of advantages in respect of seeking investment funds, including the elimination of geographical barriers by enabling individuals with one or more investment opportunities and potential investors to conduct meetings and transactions in an online environment thereby avoiding the need for individuals seeking to complete a transaction to be in the same geographical location. This is advantageous from a time and cost perspective and also avoids the need for one or both of the transacting parties to travel. Since travel accounts for an estimated 8% to 12% of global greenhouse gas emissions, reducing the need for transacting parties to travel has the associated advantage of reducing the adverse impact on the climate by reducing greenhouse emissions associated with various forms of transportation that are reliant upon fossil fuels.

The ability to conduct investment meetings and transactions in an online environment also reduces direct costs associated with travel and accommodation and enables individuals with one or more investment opportunities to connect with a large number of potential investors at relatively low cost and over a relatively short period of time. Investment transactions conducted in an online environment also enable individuals with one or more investment opportunities to efficiently present data, streamline meeting schedules, and leverage digital tools to rapidly increase their fundraising efforts.

However, investment meetings and transactions conducted in an online environment present unique challenges for the transacting parties. Such challenges include an inability to effectively develop rapport and trust between the parties as a result of the lack of physical presence. In this regard, the lack of physical presence makes it difficult for each party to read critical body language therefore making it difficult to gauge the authenticity of the other party.

Furthermore, the emergence of artificial intelligence (AI) and the generation of AI-generated profiles and images pose severe threats to digital security and trust. Such threats include the generation of highly realistic synthetic images including faces, the establishment of fraudulent bank accounts or the presence of malicious actors securing unauthorized loans and committing identity theft to commit fraud. Malicious actors may also use AI-generated images such as headshots and audio to pose as executives, thereby making it difficult to ascertain whether an individual is authentic and has the necessary bona fides to enter into a transaction.

Currently there is no efficient means by which an individual with an investment opportunity is able to connect with a range of investors in an environment that is convenient and secure for each transacting party. Accordingly, there exists a need for a system and method that addresses the abovementioned problems. In particular, there exists a need for a system and method that provides both experienced and inexperienced individuals with an equal opportunity to establish their credibility and that is not dependent upon the individuals' prior network and experience. A system and method is also required that enables individuals (both founders and investors) to readily connect with a range of individuals, in which security is afforded to the individual regarding the bona fides of the potential transacting party.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented system for facilitating connection between a user having one or more investment opportunities and one or more potential investors to enable communication therebetween, the system including, one or more processors operable to, receive and record details from a user seeking to register an investment opportunity, the details including at least a description of the goods and/or services provided, or that are to be provided, by a business associated with the investment opportunity, receive and record information from a potential investor, verify by performing a verification process, whether the user and the potential investor each has the necessary bona fides to represent their interest in the investment opportunity, the verification process requiring, the user and the potential investor to each upload an identity document and a real-time response to a randomized prompt, and the potential investor to also provide proof that they are able to commit funds that exceed a pre-defined minimum threshold, wherein the verification process further includes, determining, by the one or more processors, a total verification score for each of the user and the potential investor, wherein the total verification score for the user is based at least on the following predefined criteria, an identity criterion, a liveliness criterion and a cross-reference criterion, and wherein the total verification score for the potential investor is based at least on the following predefined criteria, an identity criterion, a liveliness criterion, and a proof of funds criterion, wherein, in the event the total verification score for the user exceeds a pre-defined total verification score threshold, the one or more processors are further operable to, generate a verified user profile, and in the event the total verification score for the potential investor exceeds the pre-defined total verification score threshold, the one or more processors are further operable to, generate a verified potential investor profile, and compare, the investment opportunity associated with the verified profile of the user with the verified potential investor profile in an attempt to establish a match between the investment opportunity and the potential investor.

It will be appreciated that existing online platforms for performing investment transactions typically request each transacting party to fill in a form to provide details of a business proposal and/or an amount of investment funds on offer, and each party simply trusts the other party's answers without performing any independent assessment regarding the credibility of the information provided.

Furthermore, the ability of a transacting party (either a founder or investor) to successfully secure a business deal typically depends on how well they represent themselves, instead of applying an objective assessment regarding the actual credibility of each party. In this regard, individuals who are experienced and present well tend to outperform less experienced individuals, despite the fact that the less experienced individual may be more genuine, credible and representing a better investment opportunity.

The system and method according to various embodiments of the present invention described herein has a number of advantages. In this regard, the present system and method uses a unique verification scoring system that achieves at least the benefit of providing an objective check regarding the credibility/authenticity of each transacting party. Accordingly, individuals will be assessed based on their credibility rather than based on their level of experience, any established professional networks, or how well the present themselves in meetings.

The unique verification scoring system according to the present invention and embodiments described herein also determines whether a potential transacting party has the necessary bona fides and only creates a user profile once the user meets or exceeds a minimum verification score threshold. This provides at least the technical benefit of conserving computing networking, processing and memory resources, since the information provided by a user during the onboarding and authentication process will not be saved to the system if the user does not satisfy the initial verification step.

The unique verification scoring system according to embodiments of the present invention also enables the system to control whether a user is visible to other users on the system, wherein only users who have the necessary bona fides (ie. who meet or exceed a minimum verification score threshold) are visible to other users. This has the associated advantage of avoiding users from entering into meetings/discussions with any individuals who may not be genuine or who may not have the necessary bona fides to enter into agreement.

The unique verification scoring system according to an embodiment of the present invention determines a user's Total Verified Score which is a uniform indicator of the user's “trust score” regardless of their country of residence, prior investment experience or type of business. In an embodiment, the verification process and trust score generation is independent of any information stored on local databases (eg. local country tax databases, or any country-specific data infrastructure), and relies instead on information that is readily available such as universal: government-issued identity documents).

In an embodiment, the verification process regarding potential investors may include an estimate regarding a private wealth profile of the investor obtained from digital information regarding the investor according to any available data source that may be interrogated that is operably connected to a data communications network such as the internet.

In an embodiment, users having investment opportunities may be required to meet a minimum standard of disclosure regarding the investment opportunity that is registered in the computer implemented system to generate an investment opportunity profile comprising various minimum requirements. Such minimum requirements may include an executive summary, overview of the market, revenue profile, expenditure, marketing estimates, personal profiles of the individuals operating the business and expected investment funds required to achieve objectives detailed in the executive summary.

In an embodiment, the computer implemented system may be operable to conduct a detailed analysis of investment opportunities such that various factors are identified including strengths, weaknesses, opportunities and threats according to a range of considerations such as barriers to market entry, investment requirements, estimated time to achieve return on investment, the quantum of return, the number of employees required, overview of business sector according to previous profits and geographical region, uniqueness of the investment opportunity, potential legal issues, estimated growth of investment and estimated return over pre-defined periods of time.

In an embodiment, the generated profiles of investment opportunities and potential investors may be supported by additional analysis of external data obtained from data sources accessible and operably connected to the internet.

In an embodiment, the interrogation of external data sources may utilise artificial intelligence techniques supported by character recognition techniques and scraping recognition technology to further support and verify profiles developed and recorded on the computer implemented system such that any identified matches between investment opportunities and investors provide both parties with a level of confidence according to verification with respect to the bona fides of all parties conducted by the computer implemented system.

In an embodiment, the verification process regarding potential investors utilises one or more artificial intelligence techniques, optical character recognition techniques or scraping technology.

In an embodiment, the system may be operable to continuously review and analyse investment opportunities and investor profiles to identify and propose potential matches that achieve or exceed a pre-defined threshold match between investment opportunities and investors wherein the continuous and ongoing identification of matching investment opportunities and investors is conducted automatically.

In an embodiment, the computer implemented system by be further operable to enable individual potential investors to indicate their interest in joining other potential investors to form an investor consortium such that individual investors when joining a consortium may receive a greater number of possible investment matches beyond those identified according to the investor acting as a sole investor.

In another aspect, the present invention provides a computer-implemented method for facilitating a connection between a user having one or more investment opportunities and one or more potential investors to enable communication therebetween, the method including, receiving and recording, by one or more processors, details from a user seeking to register an investment opportunity, the details including at least a description of the goods and/or services provided, or that are to be provided, by a business associated with the investment opportunity, receiving and recording, by the one or more processors, information from a potential investor, verifying, by the one or more processors performing a verification process, whether the user and the potential investor each has the necessary bona fides to represent their interest in the investment opportunity, the verification process requiring, the user and the potential investor to each upload an identity document and a real-time response to a randomized prompt, and the potential investor to also provide proof that they are able to commit funds that exceed a pre-defined minimum threshold, wherein the verification process further includes, determining, by the one or more processors, a total verification score for the user, wherein the total verification score for the user is based at least on the following predefined criteria, an identity criterion, a liveliness criterion and a cross-reference criterion, and determining, by the one or more processors, a total verification score for the potential investor, wherein the total verification score for the potential investor is based at least on the following pre-defined criteria, an identity criterion, a liveliness criterion and a proof of funds criterion, wherein, in the event the total verification score for the user exceeds a pre-defined total verification score threshold, generating, by the one or more processors, a verified user profile, and in the event the total verification score for the potential investor exceeds the pre-defined total verification score threshold, generating, by the one or more processors, a verified potential investor profile, and comparing the investment opportunity associated with the verified profile of the user with the verified potential investor profile in an attempt to establish a match between the investment opportunity and the potential investor.

In another aspect, the present invention provides a computer-readable medium having a plurality of stored executable instructions thereon that, when executed, cause one or more processors to perform the steps of, receiving and recording details from a user seeking to register an investment opportunity, the details including at least a description of the goods and/or services provided, or that are to be provided, by a business associated with the investment opportunity, receiving and recording information from a potential investor, verifying, by the one or more processors performing a verification process, whether the user and potential investor each has the necessary bona fides to represent their interest in the investment opportunity, the verification process requiring, the user and the potential investor to each upload an identity document and a real-time response to a randomized prompt, and the potential investor to also provide proof that they are able to commit funds that exceed a pre-defined minimum threshold, wherein the verification process further includes, determining, by the one or more processors, a total verification score for the user, wherein the total verification score for the user is based at least on the following predefined criteria, an identity criterion, a liveliness criterion and a cross-reference criterion, and determining, by the one or more processors, a total verification score for the potential investor, wherein the total verification score for the potential investor is based at least on the following pre-defined criteria, an identity criterion, a liveliness criterion and a proof of funds criterion, wherein, in the event the total verification score for the user exceeds a pre-defined total verification score threshold, generating, by the one or more processors, a verified user profile, and in the event the total verification score for the potential investor exceeds the pre-defined total verification score threshold, generating, by the one or more processors, a verified potential investor profile, and comparing, by the one or more processors, the investment opportunity associated with the verified profile of the user with the verified potential investor profile in an attempt to establish a match between the investment opportunity and the potential investor.

### BRIEF DESCRIPTION OF THE DRAWINGS

Embodiments of the invention will now be described in further detail with reference to the accompanying figures in which:

FIG. 1 provides an overview of a system according to an embodiment of the present invention showing, in particular, the interaction of various system components.

FIG. 2 illustrates an exemplary diagram associated with the server component of the system illustrated in FIG. 1.

FIG. 3 illustrates an exemplary diagram of the server component of FIG. 2 interrogated by external data sources for verification and analysis purposes.

FIG. 4 illustrates an exemplary flow diagram of a process that enables a user to download and install a software application, and subsequently access or register to use the software application, for interaction with the system illustrated in FIG. 1.

FIG. 5 illustrates an exemplary flow diagram of a process that enables a user to use the software application to register an investment opportunity.

FIG. 6 illustrates an exemplary flow diagram of a process that enables an investor to use the software application for interaction with the system illustrated in FIG. 1.

FIG. 7 illustrates an exemplary flow diagram of a process that enables the matching of investors to investment opportunities.

FIG. 8 illustrates an exemplary flow diagram of a process that enables the formation of a consortium of investors.

FIG. 9 illustrates an exemplary diagram of the server component according to an alternative embodiment of the invention, in which the system determines a user's Total Verified Score as part of the verification step.

FIG. 10 illustrates an exemplary flowchart according to an embodiment of the invention that shows a “cross-reference cascade” methodology used in determining P3.

FIG. 11 illustrates an exemplary flowchart according to an embodiment of the invention that shows how a “weighted sum” verified score is determined from each pillar.

FIG. 12 illustrates an exemplary flowchart according to an embodiment of the invention that shows how a verified score is determined for each pillar (P1 or P2).

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth in order to provide a thorough understanding of the present disclosure. It will be readily apparent, however, that the current disclosure may be practiced without limitation to the specific details. In other instances, some methods and structures have not been described in detail to avoid obscuring the present disclosure.

The present invention relates to a method for facilitating a connection between a user (30) having one or more investment opportunities and one or more potential investors (40) to enable communication therebetween. The system and method provide a platform that hosts a computer executable software application (70) wherein the application (70) is accessible by a plurality of registered users, including users (30) seeking to list their investment opportunities and investors (40) seeking to fund investment opportunities for compensation. In particular, the system may utilize a central server (20) in communication with data communication devices (60) associated the users (30) and investors (40).

It will be appreciated that general reference to investors (40) herein is intended to reference either one or a combination of investors 40A, 40B and 40C.

The central server (20) maintains one or more processors and/or databases for performing functions, including receiving and recording details from a user (30) seeking to register their investment opportunity, the details including at least a description of the goods and/or services provided, or that are to be provided, by a business associated with the investment opportunity, thereby creating an investment opportunity profile. The central server (20) subsequently receives and records information from each of the one or more potential investors (40), and verifies, based at least on the received information, whether each of the potential investors (40) meets one or more predefined criteria. This confirms whether each of the potential investors (40) has the necessary bona fides to represent their interest in the investment opportunity.

The investors (40) who satisfy the predefined criteria may then form part of a list of verified potential investor profiles eligible to appear in search results that are presented to users (20) seeking investment in relation to investment opportunities (90). The central server (20) may compare the investment opportunity profile of each user (30) with each verified potential investor profile in order establish matches between investment opportunities (90) and potential investors (40).

The person skilled in the art would appreciate that the platform provides a solution that enables users (30) such as inventors and others who have investment opportunities (e.g. inventions, property and other prospects) with investors (40) who have been verified as having the relevant bona fides to represent their interest in the investment opportunities. Once an investment opportunity (90) has been listed by a user (30), the user (30) may be presented with a list of potential investors (40), or a consortium (50) of investors (40), that match the profile associated with the investment opportunity (90). Once a potential investor (40) or consortium (50) is selected by the user (30), a connection (260) between the user (30) and the investor(s) (40) may be established. Similarly, the platform may allow for a list of available investment opportunities (90) to be presented to investors (40), to enable investors to connect and communicate with users (30).

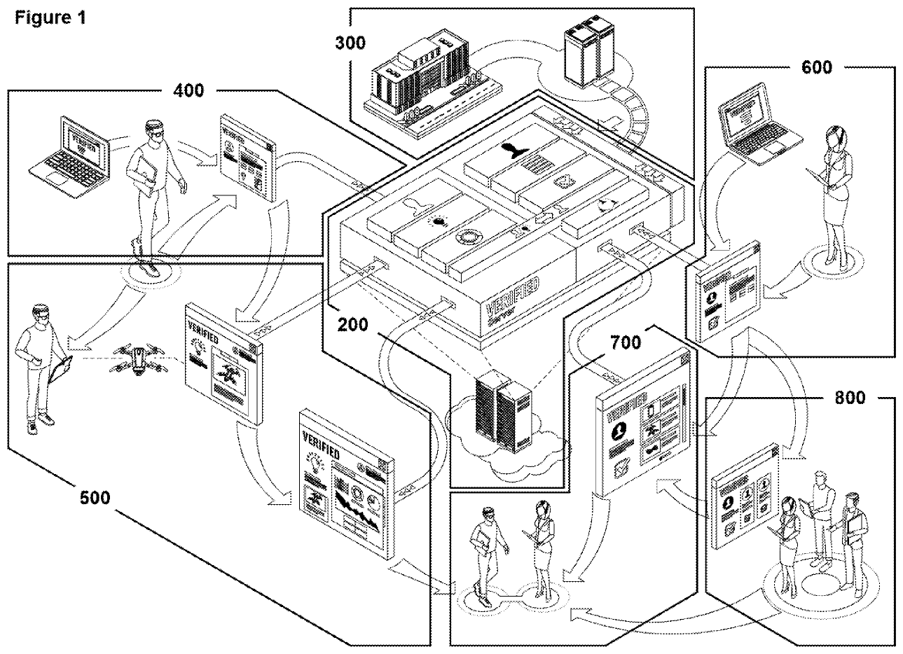

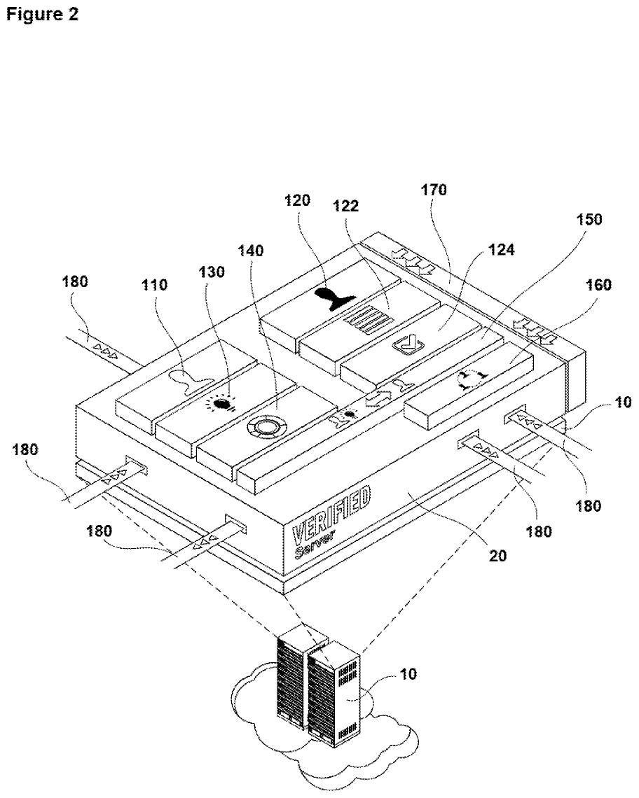

FIG. 1 is divided into segments which are further expanded in subsequent FIGS. 2 to 8. In particular, segment 200 of FIG. 1 shows the server component (20) with which the software application (70) operating on data communication devices (60) are configured to communicate. It will be apparent to the person skilled in the art that the software application (70) may be a mobile application or a web application and that, similarly, the data communication devices (60) utilised by the users (30) and investors (40) may be mobile devices or computer devices. The server component (20) is additionally detailed in FIG. 2, and the person skilled in the art will appreciate that the steps described herein, as executed by the devices (60), may be facilitated by the software application (70) operating on each device (60).

As an alternative, or in addition to, steps described herein as performed by the server (20), the steps described may be performed by one or more processors associated with the user devices (60). Different arrangements are possible in this regard, but according to a particular implementation of the present invention, the server (20) is programmed to provide all of the functions described herein where they cannot be provided locally on the user devices (60).

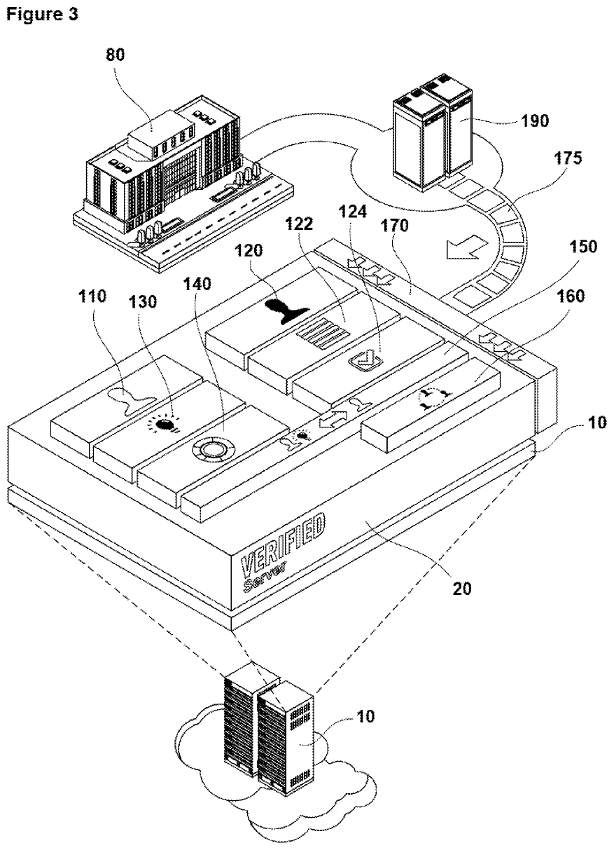

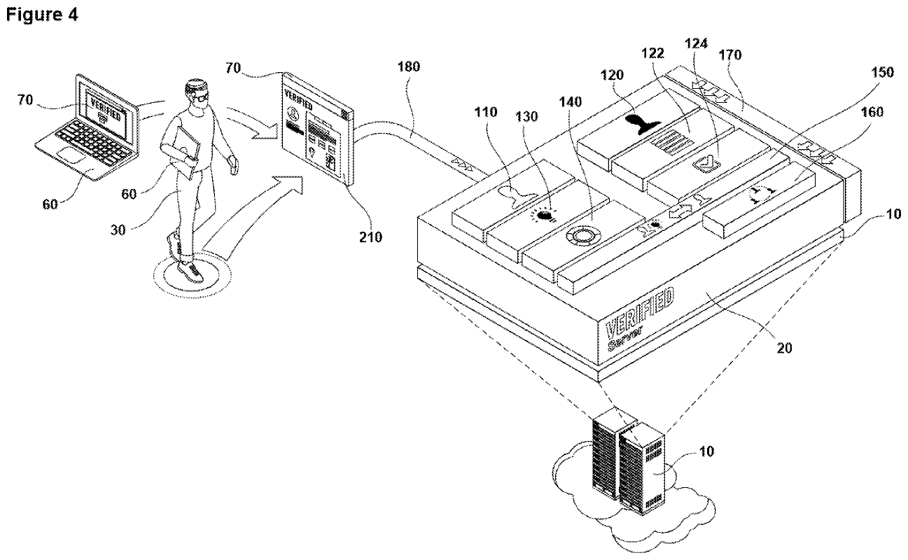

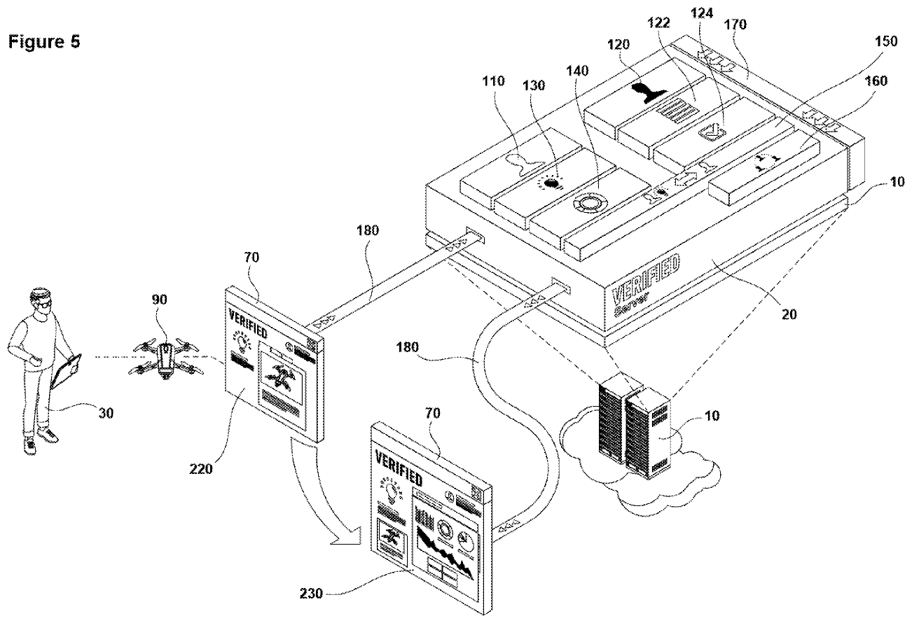

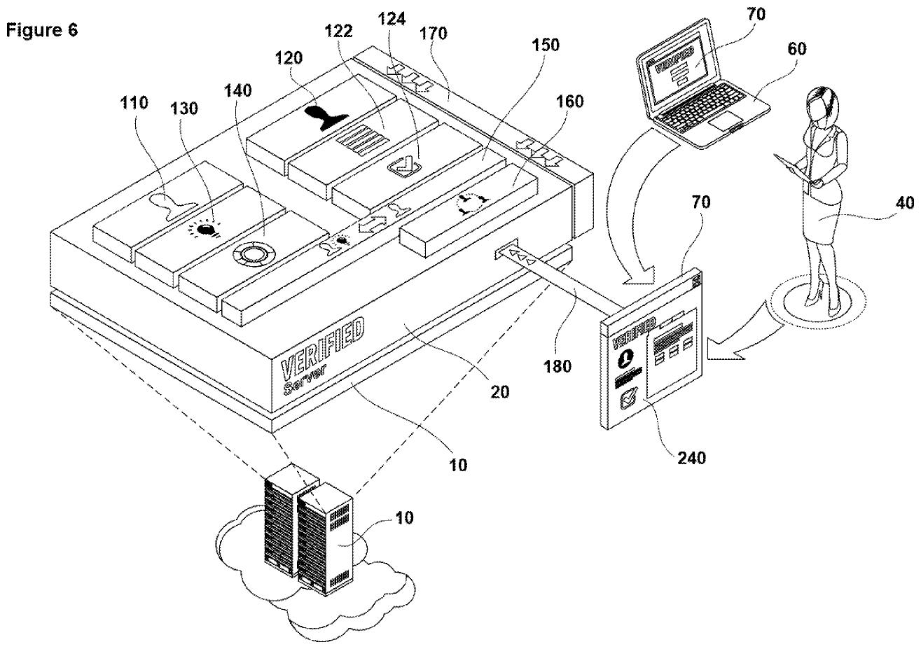

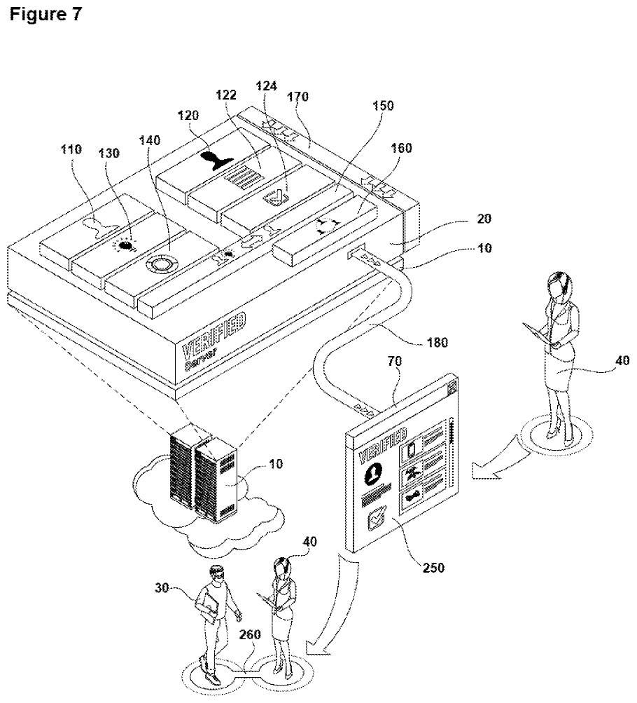

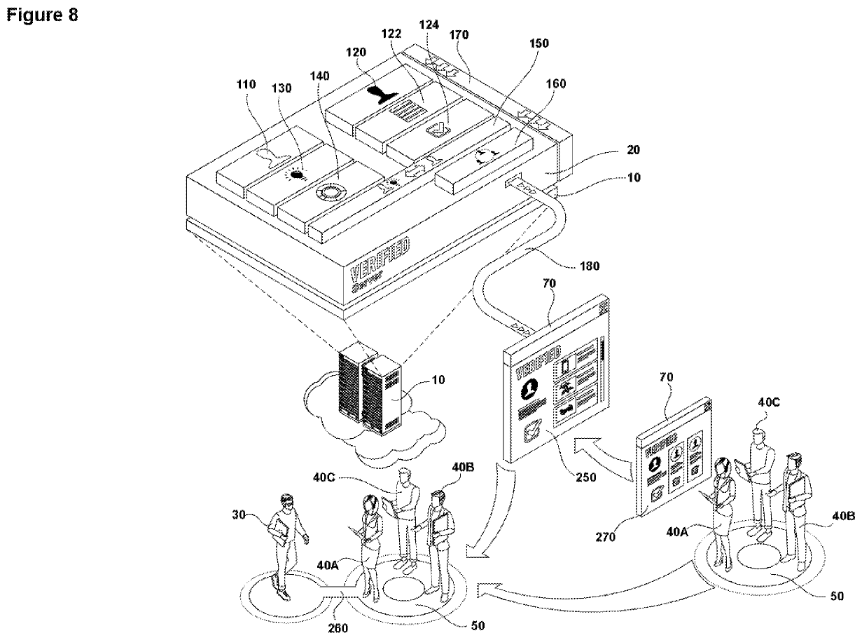

Segment 300 of FIG. 1 shows how the server (20) may be configured for interrogation by multiple external data sources (80) for the purpose of verification of users (30) and investors (40), as well as analysis of investment opportunities (90), as further detailed in FIG. 3. Segment 400 of FIG. 1 shows a user (30) downloading and installing the application (70) and subsequently accessing the application (70) in order to establish an account and investment opportunity profile(s), as further detailed in FIG. 4. Segment 500 of FIG. 1 illustrates how user (30) may list an investment opportunity (90) and enable an analysis of the opportunity to occur for the benefit of investors (40), which is further detailed in FIG. 5. Segment 600 of FIG. 1 illustrates how investors (40) can access the software application (70) and establish an investor profile, as detailed in FIG. 6. Segment 700 of FIG. 1 illustrates the matching of investors (40) to investment opportunities (90), as detailed in FIG. 7. Finally, segment 800 of FIG. 1 illustrates the formation of consortiums of investors (40), as detailed in FIG. 8.

As mentioned above, FIG. 2 shows in greater detail the segment 200 of FIG. 1 and in particular, FIG. 2 shows the server component (20) which includes infrastructure (10) upon which the platform of the present invention operates. The infrastructure (10) may be local or cloud-based. The central server (20) may operate one or more computer processors and maintain one or more databases to enable the following functionality and/or storage:
User account register 110 storing details of users (30) such as name, age, address, and contact details, and any additional data which may be relevant for the purpose of identifying each user (30). Where possible, these details will be verified using identification verification services;
Investor account register 120 storing details of investors (40) such as name, age, address, and contact details, and any additional data which may be relevant for the purpose of identifying each investor (40). Where possible, these details will be verified using identification verification services as described below with respect to feature 124;
Profile register 122 storing details relating to profiles established for users (30) in relation to their listed investment opportunities (90), and details relating to each investor's ability to invest in opportunities, along with investment preferences and areas of interest. Data stored in this register may be utilized for the purpose of determining a match between investors (40) and particular investment opportunities (90);
Verification register (124) storing the details and status of checks that have been performed on users (30) and investors (40) against, for example, one or more external databases (80). Data stored in this register may be utilized for the purpose of verifying the identification details of users and investors alike, and to ensure that each meet certain minimum criteria (e.g. ensuring that investors (40) have the bona fides to represent their interest in investment opportunities (90);
Investment opportunity register (130) storing details relating to investment opportunities that have been listed by users (30). Data stored in this register will need to meet a minimum standard of disclosure by each user (30) in relation to the investment opportunity (90), and will be utilized for the purpose of analysing the opportunities to ensure they are verified to a certain threshold and generating information for use by investors (40) to enable investors (40) to make informed investment decisions;
Analysis/Reporting engine (140) for generating information, reports and/or documents for presentation to investors (40) regarding particular investment opportunities (90) (e.g. detailed Information Memorandums (IMs), business plans, investment analysis reports, and similar documentation). The generation of this reporting information for investors (40) will be based upon data provided by users (30) in relation to their investment opportunities (90) along with additional data and information from external sources (80), as described in greater detail below;
Matching engine (150) responsible for comparing the investment opportunity profiles of each user with verified potential investor profiles to establish matches between investment opportunities (90) and potential investors (40). The matching engine (50) may rely upon the use of machine learning algorithms and the like to continuously review and analyse investment opportunities (90) and investors based on information in profile register (122) to identify and propose potential matches;
Investor consortium register (160) storing details relating to consortiums (50) of investors, i.e. a register of investors (40) who have formed consortiums (50); and
External data store (170) which may be used store data that has been collected from external data sources (80) and used for verification and opportunity analysis purposes.

FIG. 2 also depicts that server (20) is configured to enable communication (180) with the user/investor devices (60) and, in particular, the software applications (70) operating on each device (60), and FIGS. 2 and 3 show how communication (175) may be established with computer systems (190) associated with the external sources of data 80, such communications occurring via the internet or similar network.

FIG. 4 shows in greater detail segment 400 of FIG. 1 and, in particular, the steps associated with a user (30) accessing a user login and registration interface 210 associated with the application (70). Such access will be granted after the user (30) has installed the application (70), which may be achieved by downloading the application (70) from an application store. Each user (30) may create an account using the application 70 and the account information may be stored in the account register (110), and as described above, the user account register (110) may capture information sufficient to enable each user (30) to be correctly identified.

Once the application (70) has been accessed by a user (30), the user (30) may be presented with an interface identical or similar to interface (210) to allow the user (30) to create and maintain a user profile, including providing the user (30) with the ability to add/edit details and access all functionality of the application including to list investment opportunities (90) as well as to search for and view details relating to investors (40). Upon uploading sufficient information, each user (30) will be successfully registered such that the user (30) becomes a registered user who may then utilise the application's functionality.

An investor (40) seeking to download, install and register to use the application (70) would proceed through similar steps as those described above with respect to user (30). Similarly, the investor (40) may be presented with one or more interfaces (240) allowing the investor (40) to create and maintain a profile as well as to search for and view details relating to investment opportunities (90), as shown in FIG. 6 which shows in greater detail area 600 of FIG. 1. In this regard, an investor profile should capture sufficient information to demonstrate that the investor (40) is a legitimate investor having the ability to invest funds with respect to opportunities, and may further include investor preferences and areas of interest. The details submitted by investors (40) may be verified against information from the external data sources (80) to ensure they have the bona fides to represent their interest in investment opportunities (example data sources may include financial institutions, social media business accounts, private wealth profiles, and the like). Investors (40) may further be categorized into different categories or levels according to their preferences and other factors, e.g. by the amount of money they are prepared to invest, the type of funding they are prepared to provide (e.g. loan and/or equity financing), their particular qualifications and areas of interest, their preparedness to form part of a consortium of investors, etc. The categorization of investors (40) in this way will also make it easier for users (30) to search for investors (40) and filter their search results by category.

As mentioned above, FIG. 5 shows in greater detail area 500 of FIG. 1, and in particular, the use of the application (70) by a user (30) to establish a user profile and create an investment opportunity listing (220). In the example shown, the particular investment opportunity (90) relates to a novel way to control a drone. However, it is to be understood that the opportunity need not be limited to new “inventions”, and could extend to other opportunities including in relation to “property”, “new business ventures”, and any prospect for which investment funds are required (e.g. to develop a concept into a commercial offering). Once the listing has been completed, a profile relating to the particular investment opportunity is created as shown in interface (230), and this profile is viewable to investors (40) and may include one or more links to information sought by investors (40).

Similar to the requirement for investors (40) to provide sufficient information to enable their verification as legitimate investors, users (30) may also be required to submit sufficient information about themselves to verify their identity, etc (e.g. against external data sources (80) for the purpose of conducting checks such as employment checks, police checks and the like), and to satisfy investors that they are of sufficient standing and are sufficiently serious about their proposed investment opportunity. Indeed, before information and documents such as IMs, business plans and the like can be generated by the system for presentation to investors (40), a minimum amount of information must be submitted by each user (30) in relation to their investment opportunity (90). In other words, there will be a minimum standard of disclosure relating to new investment opportunity listings (220) submitted by users (30), and this submitted information will be used to create the documents and other information that are presented to potential investors to consider and decide whether they are interested in funding the investment opportunity.

Different users (30) may also be categorized into different categories or levels according to the details submitted by the users (30), including in relation to their background, the type of investment opportunity listed by the user, the amount of startup funding they have secured to date, the success or otherwise of previously listed investment opportunities, the type of funding sought (e.g. loan and/or equity financing), etc. This categorization of users (30) will also make it easier for investors (40) to search for users (30) and filter search results by user category.

It should now be apparent that the platform utilizes the data provided by users (30) when registering (220) their investment opportunities (90), along with any additional relevant data and information from external sources (80), to verify users (30) and investors (40) and to also generate detailed information for presentation to potential investors (40) in relation to the investment opportunities, including IMs and investment analytics.

In one example, the Information Memorandum may include an executive summary, overview of the market, proposed products and/or services, revenue profile, expenditure, marketing estimates, and funds required. The analysis of the investment opportunities (90) conducted by analysis/reporting engine (140) would typically take into account various factors including strengths, weaknesses, opportunities and threats. The analysis may also include a range of other considerations such as barriers to market entry, investment required, estimated time to achieve return on investment, employees required, overview of investment sector according to previous profits and geographical region, uniqueness of the investment opportunity, potential legal issues, estimated growth of investment, and return over pre-defined periods of time.

The interrogation of external data sources (80) may utilise artificial intelligence techniques supported by character recognition techniques and scraping recognition technology to further support and verify profiles developed and recorded using the platform such that any identified matches between investment opportunities (90) and investors (40) provide both parties with a level of confidence according to verification with respect to the bona fides of all parties.

When reviewing and analysing investment opportunities and investor profiles to identify and propose potential matches, a pre-defined similarity threshold may be used such that a match is achieved when the similarity between an investor and opportunity achieve or exceed the pre-defined threshold.

FIG. 7 shows in greater detail area 700 of FIG. 1 and, in particular, the automatic matching of investors (40) to investment opportunities (90) based upon a continuous analysis of newly posted/edited investment opportunities (90) and investor profiles. When an investor (40) and a posted investment opportunity (90) are automatically matched, each of the selected investor (40) and user (30) who listed the opportunity (90) may be immediately notified, e.g. by push notification, text, or email. The interface (250) in FIG. 7 represents an example interface that could be presented to at least the investor (40) confirming the automatic match with an investment opportunity (90) (in this example, the opportunity relating to the drone concept posted by user (30). This interface (250) may display or include one or more links to relevant information that the investor (40) may prefer to view prior to accepting the match and connecting (260) with the user (30), e.g. an Information Memorandum, business plan or investment analysis relating to the investment opportunity (90). Of course, the investor (40) may elect to conduct additional due diligence associated with user (30) and/or the investment opportunity (90) prior to finally agreeing to pursue the investment opportunity (90) and connect with the user (30).

It will be appreciated that investors (40) may have the option to search through a listing of investment opportunities or users who have posted investment opportunities, and may even filter through search results according to user category or the like. However, the automatic matching of investors with investment opportunities and the automatic provision of matched opportunities to investors without the need to prompt investors to conduct searches for opportunities, represents a process that assists investors in becoming aware of (and acting upon) opportunities more quickly and efficiently. Moreover, the results of automatic matching are likely to be more accurate and hence more likely to result in the securing of investment in respect of investment opportunities (90), as compared with the results of a manual search conducted by an investor (40) for example. Further, computer processing, network and memory resources that would otherwise have been consumed during the process of investors searching for opportunities will be conserved. These represent technical problems that are addressed by the implementation of the system and method described herein.

In circumstances where an investor (40) is interested in pursuing an investment opportunity (90), the platform may facilitate the connection (260) of the user (30) with the investor (40) or consortium (50), as also shown in FIG. 7.

FIG. 8 shows in greater detail area 800 of FIG. 1 and, in particular, the ability for a group of investors 40A, 40B and 40C to join a consortium (50) of investors, for the purpose of jointly funding an investment opportunity (90) associated with a user (30). A consortium could automatically be suggested in circumstances where multiple investors have been automatically matched to a particular investment opportunity (90). In other words, an interface (270) may be generated and presented to investors (40), the interface (270) displaying a listing of additional investors to whom a similar notification has been sent, and the interface (270) may allow the multiple recipients to agree to join with the other recipients. In this regard, a time limit could be placed upon the particular opportunity that is the subject of interface (270), wherein investors (40) must agree to join the consortium within a predetermined period of time after receiving the notification.

In another embodiment, only those investors (40) who have similar attributes, e.g. a similar area of interest, will be invited to join a particular consortium (50). Investors (40) may also be given the opportunity to select whether or not they are prepared to be part of a consortium at all, and any investor (40) who prefers not to be offered an invitation to join a consortium (50), will be automatically excluded from this option. It should also be understood that consortiums (50) may be formed pre-emptively, i.e. prior to any matching or posting of investment opportunities. In this way, once a consortium (50) is formed, all members of the consortium (50) may receive additional matches based upon the group of investors (40) collectively having attributes that meet the requirements of the investment opportunity, e.g. based on the group collectively having more investment funds.

The Total Verified Score Associated with Each User Profile

A Total Verified Score (TVS) is a consistent, evidence-based credibility indicator that provides a uniform “trust signal” for every founder and investor, regardless of their geography, experience or background.

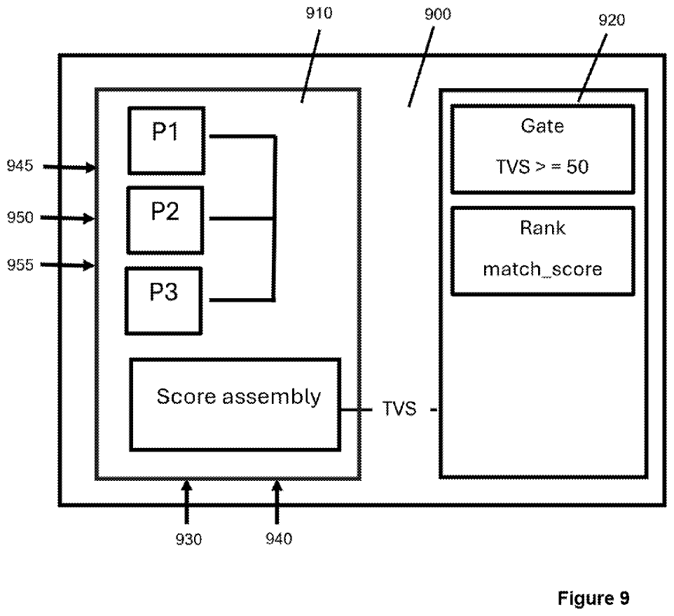

The system used to generate a Total Verified Score in accordance with an embodiment of the present invention is shown in FIG. 9. According to this embodiment, the system includes a central server (900) in which a verification engine (910) and matching engine (920) are located. Verification engine (900) is configured to receive founder information (930) from individuals having one or more investment opportunities (founders). Verification engine (910) also receives investor information (940) from one or more investors. Founder information (930) and investor information (940) are also sent a third-party KYC vendor for analysis (using various forensic techniques as will be further discussed herein) to generate a “KYC vendor (P1 or P2) score” (945) which is provided as input into the system. Founder information (930) and investor information (940) are also analysed for authenticity by the system using various AI techniques to generate an “AI (P1 or P2) score” (950) which is also provided as input into verification engine (910). The system also obtains publicly available information (955) from, for example, various online websites (eg. LinkedIn, Facebook and social media feeds) to calculate a P3 pillar score. The verification engine (910) then calculates a Total Verified Score (TVS) based on the calculated P1, P2 and P3 scores and inputs the TVS into matching engine (920) which determines whether an individual (founder or investor) is available to be matched based on their TVS (ie. any individual with a TVS>=50 is available to be matched).

It will be appreciated that in various embodiments, central server (900) may include additional components according to one or more other embodiments as described herein. For example, central server (900) may include one or more additional components of the central server illustrated in FIG. 2 of the present invention.

A founder may have a number of business opportunities in respect of which they seek investment funds. Likewise, an investor may be interested in a number of business opportunities. In an embodiment, the TVS associated with a founder or investor is associated with their user profile, and therefore can apply across one or multiple business opportunities.

According to an embodiment, a user's Total Verified Score (TVS) (whether the user is a founder or an investor) is a number between 0 and 100 associated with each user account and to functions as a “trust score”. In other words, a user's Total Verified Score provides an indication of the bona fides (with respect to, for example, their credentials, qualifications, representations, good faith, honesty) and does not function as a measure of business quality, investment potential or likely success of a business opportunity.

For example, a user who has one or more investment opportunities and is seeking to find one or more investors will have a Total Verified Score of 0 upon establishing a user account. Once the user uploads their identification information (credentials) including their name, address, birthdate, government issued identification (eg Driver's Licence, Passport, etc) and a personal photograph/video feed, and the system commences various background checks, the user's Total Verified Score will increase.

The Total Verified Score associated with a user's personal profile will determine whether they have the minimum required bona fides for their profile to be visible to other users (and accordingly whether they are available to be matched with, and contacted by, other users).

In an embodiment, a minimum (threshold) Total Verification Score is pre-defined (or pre-set) and any user profiles that do not meet or exceed the pre-defined minimum Total Verified Score threshold, will either be removed or will not be visible to other users (eg. potential investors).

### Calculation of a User's Total Verified Score

According to embodiment, the Total Verified Score associated with a user is determined using three criteria (ie. “pillars”) wherein each pillar is determined independently of the other pillars and is allocated an individual score between 0 and 100.

### The Three Pillars of the Total Verified Score

The three pillars (P1, P2 and P3) include (i) an Identity pillar, (ii) a facial recognition and/or liveliness pillar, and (iii) an external verification or cross-reference pillar where:

Pillar 1 (P1) represents a measure of the authenticity and trustworthiness of the information provided by the user to establish identity;

Pillar 2 (P2) represents a measure of the degree of similarity between the user's facial features (captured in a photograph or video feed) and the photograph extracted from one or more verification documents associated with the user. In various embodiments, P2 also provides a measure of a user's liveliness to determine whether the user is a live person (as compared with, for example, a synthetic (AI-generated) image; and

Pillar 3 (P3) represents the degree of agreement between data/information interrogated and/or obtained from one or more external sources (eg. LinkedIn, Facebook, social media feeds) associated with the user and the information provided by the user.

The system may support two trigger paths:
1. Automatic trigger upon upload—The user uploads their image through the system application which automatically creates a verification record and dispatches the image to the third-party KYC vendor and also the verification engine of the present invention for further analysis using one or more artificial intelligence (AI) techniques to determine P1 and P2. Verification and determination of P1 and P2 is automatically triggered upon a user uploading their image without separate selection of a “start verification” button required.
2. Hosted flow—The user selects a single button in the system application and is automatically redirected to the third-party KYC vendor's hosted verification flow to determine P1 and P2. Once at this point, the vendor's system performs the steps of document capture and analysis, face capture, video capture and liveliness analysis.

In an embodiment, to determine pillars 1 and 2, the verification engine and an analysis system associated with a third-party Know-Your-Client (KYC) vendor, conduct separate analyses in parallel to determine P1 and P2.

It will be appreciated that the pillars are not produced at the same time. The third-party KYC vendor analysis system and the verification engine of the present system are capable of working in parallel to determine a single pillar, and also across pillars in circumstances in which the user supplies (uploads) information where that information may be separated by minutes, hours or even days apart. The verification of the present system is able to handle the separate upload of information by the user since the verification engine calculates a total verified score according to whichever pillar has been determined based on the available information. In other words, each time a user uploads new information, or the system detects new information associated with a user (eg. a new Facebook or LinkedIn entry), and re-calculates each pillar as a complete re-assembly event (ie. it does not maintain a partial running of sums), and calculates a Total Verified Score based on the pillars determined to that point.

It will also be appreciated that according to various embodiments, the determination of pillar 3 (P3) is the only pillar that is not user-initiated, and instead, determination of P3 is automatically triggered upon P1 meeting a minimum threshold (ie. when P1 reaches a “passed” state according to the information uploaded by the user.

Furthermore, P3 is the only pillar that is determined in the absence of any third-party KYC vendor involvement, and is determined solely according to the analysis performed by the verification engine of the present system using one or more AI techniques.

In circumstances where a third-party KYC vendor is not available (for example, when on-boarding a vendor during system set-up, or when a vendor signal is not present due to a vendor outage), the verification engine converts to “AI-only fallback” mode, in which the system runs solely based on analysis performed by the verification engine using various artificial intelligence techniques and without any third-party KYC vendor involvement. Under these circumstances, P1 and P2 are determined based solely on analysis conducted by the verification engine, and since P3 is always calculated solely by the verification engine (ie. without any involvement by a third-party KYC vendor), the verification system can continue to calculate P1, P2 and P3 when a third-party KYC vendor is not available or absent. In other words, embodiments of the present system may be configured to enable the verification engine to continue to determine a user's Total Verification Score even in the event a third-party KYC vendor is unavailable.

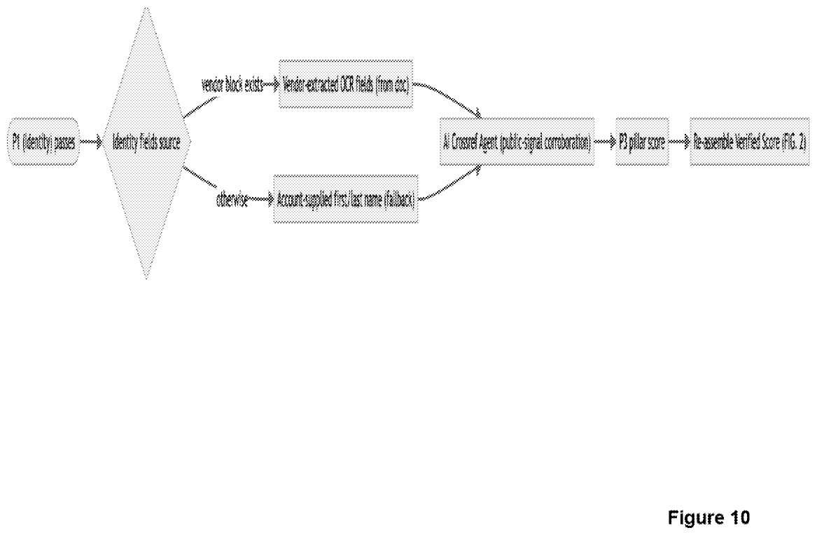

In order to determine P3 by cross-referencing various information, the verification engine of the present system requires at least a user first name and surname (“identify fields”). The system may use a “dual source” configuration (illustrated in FIG. 10) in which there are two possible sources of this information:
1. Extracted identify fields using OCR technology provided by the third-party KYC vendor (in the event a third-party KYC vendor is available) upon analysis of the user's government-issued document; and
2. If a third-party KYC vendor is not available, or in the absence of provision of OCR-extracted identify fields to the system, the system uses, as a “fallback” position, the identify fields provided by the user during sign-up and account establishment.

The “dual-source” configuration means the “cross-reference” analysis step to determine P3 proceeds in circumstances where a third-party vendor is unavailable (either prior to on-boarding or due to vendor outage).

Determining a verified score for P1 involves collecting information associated with a user's credentials and includes, for example, a user's government-issued identification documents (eg. Driver's Licence, Passport etc).

To determine P1 and P2, the information in the government-issued document is subjected to an analysis by the system application using various artificial (AI) techniques and also an analysis by a third-party Know-Your-Client (KYC) vendor to determine:
(i) is/are the uploaded government-issued document(s) authentic? (Pillar 1)
(ii) does the information included in the uploaded government-issued document match the information provided by the user? (Pillar 2)

As part of this analysis, the system uses, either directly and/or through a third-party Know-Your-Client (KYC) vendor, one or more natural language processing techniques, optical character recognition techniques and/or artificial intelligence (AI) technology to extract and analyse the information contained in the document.

Once the analysis is complete, the system generates a verified score from 0 to 100 for P1 according to analysis of the information provided by the user.

Once a user uploads one or more government issued documents during the process of verifying their identify (eg. a Passport or Driver's Licence), the system compares the images associated with each uploaded document and also compares these images with a personal image capture and/or video feed captured and uploaded by the user.

According to various embodiments, a measure of an individual's “liveliness” is also determined as part of the authenticity check by the user uploading a video feed to the third party KYC vendor, either by (i) the central server (which generates a short-lived signed URL for the vendor to fetch the video feed from an object store), or (ii) directly to the vendor via the vendor's mobile software development kit (SDK) embedded within the system's application. A measure of an individual's liveliness score is reported as part of the P2 verified score).

The authenticity of the video feed may be assessed frame by frame using one or more of the following techniques:
passive liveliness detection (analysing skin texture, lighting consistency and image-frequency signals from a single frame;
active liveliness detection (requiring the user to perform a randomly selected action such as turning their head, blinking or following an on-screen prompt);
generative-image detection (identifying artefacts characteristic of synthetic faces produced by generative AI models).

As part of the analysis to determine the P2 verified score, the system takes into account whether the personal image uploaded by the user is a static image capture, a video feed or an altered image or video feed (eg. altered by artificial intelligence). For example, the system will generate a higher P2 verified score according to an uploaded (unaltered) video feed as compared with a static (unaltered) image capture.

Similarly, the system will generate a higher P2 verified score based on an unaltered static image capture as compared with an altered video feed.

The P2 verified score will also depend upon the degree of similarity between the uploaded image capture and/or video feed and the image included in the verification document(s) (eg. Passport, Driver's Licence etc).

Determination of the P3 verified score involves an automatically initiated cross-reference (comparison) between the information provided by users and information automatically obtained by the system by interrogating information contained in, or obtained from, one or more external sources including, but not limited to, the internet, social media (eg. Facebook, Instagram), LinkedIn profiles, adverts, news stories/feeds, taxation office databases/registers, state revenue office databases/registers, business (company) registers, intellectual property databases/registers etc.

In an embodiment, determination of the P3 verified score is comprehensively AI implemented without the need for human intervention or third-party KYC vendor involvement and the system identifies and interrogates publicly available information from the internet across various websites and platforms and/or information located in one or more local and/or foreign business registers (eg. Australian Securities and Investments Commission (ASIC) register which is Australia's corporate, markets and financial services regulator). Such business registers typically contain a vast amount of publicly available information that is useful to verify the legitimacy, ownership and history of businesses and operating professionals.

The system determines a P3 verified score based upon the degree of similarity between the information provided by the user and the information obtained and/or interrogated by the system from the internet and/or various external sources.

### Determination of a Total Verified Score Based on the P1, P2 and P3 Verified Scores

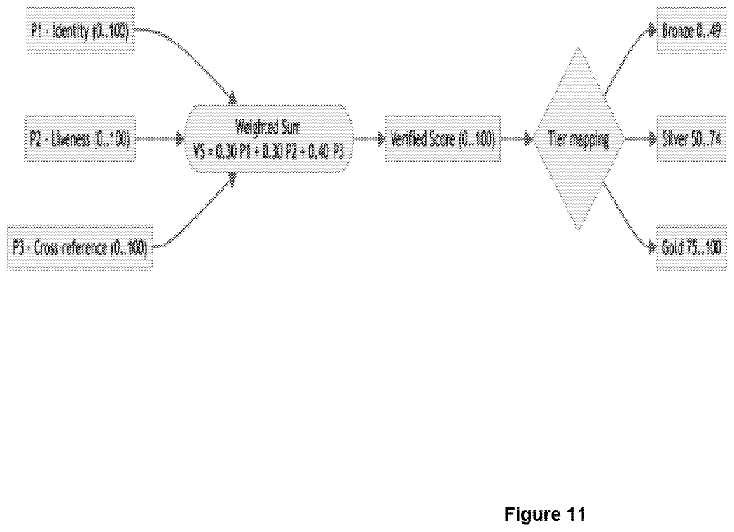

With reference to FIG. 11, in an embodiment, the system of the present invention determines a “weighted sum” verified score based on each pillar (P1, P2 and P3). The score for each pillar is determined in isolation of the score associated with the remaining pillars such that the “weighted sum” of pillars P1, P2 and P3 may be calculated even when a score associated with one or two pillars is not available. It will be appreciated that a verified score for each pillar can be determined and repeated as required, and can expire after a set period of time without affecting the verified score of the other pillars.

The separation in the determination of each pillar verified score is important and has various advantages particularly in the event a Total Verified Score based on any one or two of the three pillars is sufficient to meet the threshold requirement (ie. a minimum Total Verified Score) to enable a user to be visible and available to connect with other users (eg. potential investors), even though the verified score of one or two of the individual pillar(s) is yet to be determined or expires.

In this regard, skilled readers will appreciate that analysing and verifying various information can be intensive when considered from a time, cost and computer processing and networking perspective. Accordingly, the ability to determine a user's Total Verified Score based solely on one or two of the three pillars, may save time, avoid unnecessary expense and reduce (conserve) computer processing and networking resources.

### How the Verified Score is Determined for Each Individual Pillar

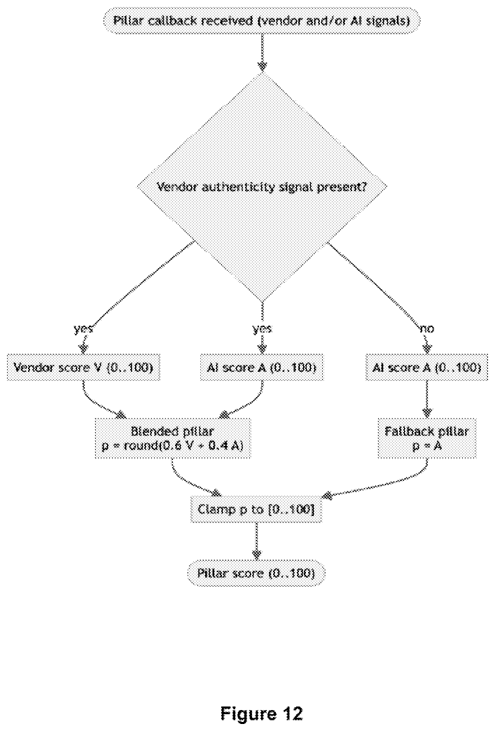

FIG. 12 illustrates a flowchart that shows how a verified score is determined for each pillar (P1 or P2).

To determine P1, the user captures an image of a government-issued document (eg. their Passport or Driver's Licence), which is provided to the third-party KYC vendor either by (i) the central server (which generates a short-lived signed URL for the vendor to fetch the image from a document object store), or (ii) directly to the vendor by the vendor's mobile software development kit (SDK) embedded within the system's application.

Once uploaded, the verification documents (eg. Passport, Driver's Licence) are forwarded to a third-party Know Your Client (KYC) vendor to determine the authenticity of the document(s). As can be seen from FIG. 12, once a user uploads their government-issued document (eg. a Passport or Driver's Licence), the verification process is automatically triggered, and the system initially checks whether a third-party KYC vendor signal is present (ie. whether a third-party KYC vendor has been on-boarded and is available). If the system detects a third-party KYC vendor signal, the system automatically sends a copy of the government-issued document to the third-party KYC vendor for analysis and determination of P1.

To determine P1, authenticity of the government-issued document is checked by the third-party KYC vendor using various forensic techniques including checking holograms on a Passport, the MRZ checksum (a mathematical verification digit built into the machine-readable zone (MRZ) of identity documents), and/or security threads (thin metallic, polymer or strip embedded directly onto the substrate of documents during manufacturing which provides a primary, visible/detectable anti-counterfeiting measure during authentication).

Once the authenticity check of the document has been completed by the third-party KYC vendor, the third-party KYC vendor provides a number between 0 and 100 (“KYC vendor (P1) score”) as an indicator of their confidence regarding the authenticity of the document. The KYC vendor also provides a literal verdict (pass, manual review or fail) regarding the authenticity of the document according to their analysis.

The KYC vendor also uses Optical Character Recognition (OCR) technology to extract data from the document(s) and this extracted data is provided to, and used by, the present system in further analysis using AI technology. In particular, the present system uses this extracted OCR data to determine the similarity (degree of agreement) between the information provided by a user and the information contained in the verification document(s). All of the information obtained from the “further analysis” conducted by the present system is used to determine an “AI (P1) score”.

The P1 verified score (ie. P1 “Blended Pillar”) is then calculated according to the following equation:

$$P 1 = ( 0.6 \times KYC vendor ( P 1 ) score ) + ( 0.4 \times A I ( P 1 ) score ) ,$$

wherein:
P1 is rounded to the nearest whole number, and
P1 is restricted (or “clamped”) to values between 0 and 100 (eg. if a P1 value of 102 is calculated, then it would be restricted to 100

To determine P2, the personal image capture or video feed uploaded by the user is also forwarded to the third-party Know Your Client (KYC) vendor to determine the authenticity of the photograph or video feed.

More specifically, the user captures an image of themselves using, for example, the camera functionality on their user device (eg. smartphone) and uploads the captured image to the system which is provided to the third-party KYC vendor.

In an effort to increase their Total Verification Score, the user may also elect to upload a video feed of themselves performing an action as prompted by the system (for example, to turn their head) which is also provided to the third-party KYC vendor.

The third-party KYC vendor runs a biometric-face match and a liveliness analysis (if the user has also elected to upload a video feed) to determine a similarity between the image captured in the government-issued document and the image and/or video feed provided by the user.

Once the authenticity check of the image capture or video feed has been completed, the third-party KYC vendor provides a number between 0 and 100 (“KYC vendor (P2) score”) as an indicator of their confidence regarding the authenticity of the image capture or video feed. The KYC vendor also provides a literal verdict (pass, manual review or fail) regarding the authenticity of the image capture or video feed according to their analysis.

The present system also conducts an independent analysis of the image or video feed uploaded by the user to determine the authenticity of the image or video feed and also the similarity between the facial features captured in the uploaded image or video feed and the image included in the uploaded verification document(s) (eg. Passport, Driver's Licence etc.) to provide an “AI (P2) score”.

In this regard, the verification engine of the present system compares the image and/or video feed provided by the user using a multi-modal large language model with vision capability. It evaluates feature similarity between the user's photograph associated with the government-issued document and the image uploaded by the user, detects artefacts of synthetic generation or image manipulation, and adjusts confidence for image-quality signals such as blur, glare and resolution.

The verification engine of the present invention also independently analyses the video-feed (if uploaded by the user) and checks for micro-movement, blink and parallax.

The P2 verified score (ie. P2 “Blended Pillar”) is then calculated according to the following equation:

$$P 2 = ( 0.6 \times KYC vendor ( P 2 ) score ) + ( 0.4 \times A I ( P 2 ) score ) ,$$

wherein:
P2 is rounded to the nearest whole number, and
P2 is restricted (or “clamped”) to values between 0 and 100

It will be appreciated that an increased weighting allocated to the KYC vendor (P1)/(P2) score (60%) as compared with the 40% weighting allocated to the AI (P1)/(P2) score in the above equations takes into account that the third-party KYC vendor is a regulated specialist and accordingly, is expected to have a higher degree of confidence associated with its authenticity check due to its sophisticated forensic capability.

It will also be appreciated that the AI (P1)/(P2) score effectively provides an independent “second opinion” with a lower, yet meaningful, weighting.

FIG. 12 also illustrates how a pillar score (either P1 or P2) may be determined in circumstances where the third-party KYC vendor is unavailable. In these circumstances, when the system fails to detect the presence of a third-party KYC vendor signal, the system calculates a “Fallback pillar” score (either P1 or P2) based solely on the analysis performed by the verification engine using various AI techniques.

To determine the P3 verified score, the system is fully AI driven without the need for a third-party KYC vendor involvement and identifies and interrogates publicly available information from sources including, but not limited to, the internet, social media (eg. Facebook, Instagram), LinkedIn profiles, adverts, news stories/feeds, taxation office databases/registers, state revenue office databases/registers, business (company) registers, intellectual property databases/registers etc.

The system determines a P3 verified score based on the degree of similarity between the information provided by the user and the information obtained and/or interrogated by the system from the internet and/or various external sources by using various AI techniques as follows:

$$P 3 = A I ( P 3 ) score )$$

wherein:
P3 is rounded to the nearest whole number, and
P3 is restricted to values between 0 and 100

### Combination of the P1, P2 and P3 Verified Scores to Provide a Total Verified Score

Once P1, P2 and P3 have been determined (or whatever subset of the pillars have been computed to the present point in time) the Total Verified Score (TVS), according to an embodiment, is calculated as a weighted sum as follows:

$$TVS = ( w 1 \times P 1 ) + ( w 2 \times P 2 ) + ( w 3 \times P 3 )$$

wherein:
TVS is rounded to the nearest whole number,
TVS is restricted to values between 0 and 100,
w1=0.3
w2=0.3 and
w3=0.4

It will be appreciated that the highest weight (0.4) has been allocated to P3 since the step of cross-checking the information provided by the user against publicly available information located on the internet and publicly available databases is the most difficult to fraudulently produce, and accordingly, provides the most informative single check.

Since a TVS may be calculated even when one or more of the pillars are either yet to be determined, expire, or waiting to be updated, the lower weight allocated to P1 and P2 also ensures that a user's TVS will not exceed the minimum threshold simply by uploading their passport and personal details and image. In other words, a user will likely have to pass at least the cross-reference step of P3, in order to have a TVS that is high enough to meet or exceed the pre-defined threshold.

In this embodiment, users having an investment opportunity who are seeking an investor, and investors seeking an investment opportunity, are both attributed the same weights (ie. 30% (P1)/(30% (P2)/40% (P3)) in the equations detailed above. However, it will be appreciated that the weights may vary for each entity according to alternative embodiments.

### EXAMPLE

Consider an individual (the user) who has an investment opportunity and who seeks a potential investor.

The user uploads a copy of their US passport:

The third-party KYC vendor returns:
an authenticity (KYC vendor (P1)) score of 92.

The third-party KYC vendor also returns:
a literal verdict of “pass”; and
OCR fields with first name: Jane, last name: Doe.

Based on this information, the present system determines, using AI technology, an AI (P1) score of 85.

Accordingly, the P1 score is determined as follows:

$$P 1 = ( 0.6 \times 92 + 0.4 \times 85 ) = 89.2 ( rounded up to 89 )$$

The user subsequently uploads a personal image capture (ie a “selfie”).

The third-party KYC vendor returns:
A “face match” KYC vendor (P2)) score of 90.

The third-party KYC vendor also returns:
A literal verdict of “pass” for the liveliness check.

The present system also determines, using AI technology, an AI (P2) score of 88 (based on the face check).

Accordingly, the P2 score is determined as follows:

$$P 2 = ( 0.6 \times 90 + 0.4 \times 85 ) = 89.2 ( rounded up to 89 )$$

Meanwhile, as part of determining P3, the system uses AI technology and automatically interrogates the internet and specifically searches for “Jane Doe” on LinkedIn. The system identifies the relevant LinkedIn profile, and also a news article that names the user (Jane Doe) as the founder of Acme Pty Ltd. Upon cross-checking the Acme Pty Ltd website, the system determines a match between the name “Jane Doe” in the LinkedIn profile, the news article that name “Jane Doe” as the founder of Acme Pty Ltd, and returns a P3 score of 78.

Accordingly, the Total Verified Score is determined as:

$$TVS = ( 0.3 \times 89 ) + ( 0.3 \times 89 ) + ( 0.4 \times 78 ) = 84.6 ( rounded up to 85 )$$

### Display of Total Verified Score Tiers

In an embodiment, the Total Verified Score from 0 to 100 is divided into three tiers, Bronze, Silver and Gold as follows:

| Total Verified Score | Tier |
|---|---|
| 0 to 49 | Bronze |
| 50 to 74 | Silver |
| 75 to 100 | Gold |

These tiers are typically displayed on the user interface against the user's personal profile instead of a raw Total Verified Scores since “Gold”, “Silver” and “Bronze” are more readily recognised by users as compared with a raw score between 0 and 100.

Accordingly, with regard to the example pertaining to Jane Doe provided above, the user interface would display a Tier of “Gold” within Jane Doe's profile based on her Total Verified Score of 78.

### Determination of Verification Tier

The system also determines a “Verification Tier”, which is different to a Tier associated with a “Total Verified Score”. The Verification Tier, is a number between 0 and 3 and is a count of how many verification pillars (types) a user has passed as follows:
Tier 0: no pillars passed as yet
Tier 1: P1 passed
Tier 2: P1 and P2 passed
Tier 3: P1, P2 and P3 (cross reference or accredited investor) passed.

It will be understood that the Verification Tier is separate to the Bronze, Silver or Gold Tier associated with the Total Verified Score. For example, a user may have a Verification Tier 3 based on three “weak” P1, P2 and P3 passes, and a “Silver” Total Verified Score Tier, whereas another user may have a Verification Tier 1 based upon one very strong pass in P1, and also a “Silver” Total Verified Score Tier.

### Automatic Commencement of P1, P2 and P3 Verification Upon a User Uploading Information

In an embodiment, once a user uploads any information (eg. their image and passport), the system automatically commences a verification process upon receiving that user information. Accordingly, the system does not include a separate user step or “start verification” selection to initiate the verification process. It will be appreciated that this is a deliberate implementation choice and provides at least the technical benefit of avoiding the accumulation of stored data in the system that may never undergo verification and effectively consumes storage space.

Accordingly, when a user uploads their verification document and personal image or video feed to the system, that action automatically initiates an instruction for the one or more system processors to commence the verification step and send the uploaded information to the third-party KYC vendor for authentication and generation of KYC (P1 and P2) verification scores.

Simultaneously, the system also automatically dispatches the same uploaded information to the AI engine, wherein the one or more system processors perform a separate verification step to generate AI (P1 and P2) verification scores.

It will be understood that the user will not be required to confirm that verification is to commence thereby avoiding storage of information that is neither analyzed nor used by the system thereby avoiding wastage of computer memory resources.

The system may also automatically perform the following actions:
The cross-reference step for determining the P3 verification score initiated using the OCR generated data provided by the KYC vendor during the P1 verification step. In an embodiment, the cross-referencing step is initiated as soon as P1 receives a “pass” rating from the third-party KYC vendor.
The user's profile is converted into a vector and stored in memory such that matching may start as soon as the rest of the profile is ready.

Accordingly, in an embodiment, a user's profile is only stored in memory once verification has occurred and at least one of P1, P2 and P3 have been determined. Skilled readers will appreciate that by avoiding the use of a two-step verification initiation process (ie. where a user is required to upload information and then confirm that verification is to occur), and also, by converting the user's profile into a vector only after verification has commenced, avoids the storage of unverified data that would otherwise consume valuable computer memory storage.

### Data Storage and Auditing Considerations

Every score produced by the system is reproducible and for each verification, the system stores:
The raw data uploaded by the user;
The analysis results from the AI engine;
All inputs, outputs, confidence, and duration associated with each step including upload, analysis, storage and display.
A user's reference (check) ID, in the event the user's internal audit record is required; and
The AI agent ID and the model version to ascertain which version of the AI agent produced a user's score at any point in time.

Accordingly, if a query is received in future regarding why a particular user received a specific TVS, the raw data may be retrieved and a step by step analysis may be reproduced upon request. The analysis may also be performed under different weightings to determine whether the allocated weightings should change.

In an embodiment, the system continuously analyses available information in relation to information maintained and/or updated within a user's profile and internet history and determines an updated TVS according to any updated/changed information. Accordingly, the system is dynamic in the sense that it responds to any change in information (for example, a new image, a new internet post, an amended LinkedIn profile associated with the user). It will be appreciated that by conducting a continuous review of the information associated with a user, the currency of a user's Total Verified Score is able to be maintained.

In an embodiment, the system periodically updates and analyses a user's information to take into account changes in any uploaded information or any publicly available information available on the internet or in various external databases. In an embodiment, the system may be configured to automatically re-analyze information and update verification scores of a user upon receiving and/or detecting any new information. It will be appreciated that this action assists to conserve computer processing and networking resources since the system avoids the need to conduct a continuous review of available information in order to maintain a current TVS of a user.

In an embodiment, a user's Total Verified Score will expire after a pre-set period (for example, 365 days after completing verification). This takes into account expiry of verification documents (eg. Passports), any changes in an individual's facial features over time, and/or changes in publicly available information.

Matching Individuals with Investment Opportunities with Potential Investors Engine

There are two distinct uses of the Verified Score inside the matching engine:
1. Use within a “hard-gate” matching layer which operates at the database query level and excludes any individual that does not satisfy all of:
   Having an opposite “user type” to the requestor so that individuals having a user type “founder” are only matched to individuals having a user type “investor” (and vice versa);
   Have a TVS at, or above, the predefined “visibility” threshold;
   Have passed the identity verification step (P1 score determination).

As a result of the “hard-gate” matching layer, the matching SQL query only considers users whose Total Verified Score is 50 or higher, and accordingly, a Bronze user, for example, is effectively “invisible” to the matching engine. This is an SQL level filter, which means users with a TVS lower than 50 are never matched thereby conserving computer processing and networking resources.
2. Use within a “soft-gate” scoring layer, which is applied to individuals that pass the “hard-gate” matching layer. For each founder opportunity/candidate investor pair, a match score is computed.

As a rank weight within the “soft-gate” matching layer, for users who have a TVS of 50 or higher, the matching engine takes a small fraction of its final match score (for example, 5 percent), to calculate a “trust bonus”. The trust bonus is a function of the candidate's Total Verified Score. Two candidates with otherwise identical thesis, industry and stage fit will be ordered by their “trust score” if one is more verified than the other.

In one embodiment, the full match score is determined as follows:

$$match\_score = 0.25 \times thesis\_fit + 0.2 \times industry\_fit + 0.15 \times stage\_fit + 0.15 \times size\_fit + 0.1 \times pitch\_relevance + 0.1 \times location\_fit + 0.05 \times trust\_bonus$$

wherein:
the “thesis fit” is the cosine similarity between a founder's company description and the description of the investor's interests;
the “industry fit’ represents how well a founder's industry matches with the industries the investor has indicated their investment preference. For example, if a founder's business opportunity resides in the field of “fintech” and the investor indicates that they are interested in investing in one or more “fintech” industries/opportunities, then this will be a strong “industry fit”;
the “stage fit” represents the stage of development of their business opportunity—for example, if the founder is at the “seed stage” and the investor is only interested in “seed deals” then this will be a strong “stage fit”.
the “size fit” is based on the investment amount required by the founder to fund their business opportunity;
the “pitch-relevance” is based on how well a founder's actual proposal/pitch (eg. how well they describe their company, the problem they are solving, the traction they have) accords with an investor's interests; and
the “location-fit” is based on whether the founder is located in a location of interest to the investor.

The trust bonus for a user is approximately (TVS minus 50) divided by 50, capped at 1. Therefore, a Silver Tier user with a TVS of exactly 50 contributes a trust bonus of 0, and a user with a TVS of 100 contributes a trust bonus of 1. In absolute terms the bonus is small (eg. 5 percent of the total) but it matters at the margins when the other dimensions are close.

### Idempotency

The AI engine runs asynchronously, which means callbacks can be redelivered. The backend is configured to handle the same callback arriving two or three times without producing a different final score. This is achieved by reading the user's current data, recomputing the verification score from the freshly merged inputs, and recording the re-computed value. Accordingly, the determined verification score will be identical based upon the same user information without the risk of causing duplicate data or system errors.

As used herein, the term “central server”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented system for facilitating connection between a user having one or more investment opportunities and one or more potential investors to enable communication therebetween, the system comprising:
one or more processors operable to:
receive and record details from a user seeking to register an investment opportunity, the details comprising at least a description of the goods and/or services provided, or that are to be provided, by a business associated with the investment opportunity;
receive and record information from a potential investor;
verify by performing a verification process, whether the user and the potential investor each has the necessary bona fides to represent their interest in the investment opportunity, the verification process requiring:
the user and the potential investor to each upload an identity document and a real-time response to a randomized prompt; and
the potential investor to also provide proof that they are able to commit funds that exceed a pre-defined minimum threshold, wherein the verification process further comprises:
determining, by the one or more processors, a total verification score for each of the user and the potential investor,
wherein the total verification score for the user is based at least on the following predefined criteria:
an identity criterion;
a liveliness criterion and
a cross-reference criterion; and
wherein the total verification score for the potential investor is based at least on the following predefined criteria:
an identity criterion;
a liveliness criterion; and
a proof of funds criterion;
wherein:
in the event the total verification score for the user exceeds a pre-defined total verification score threshold, the one or more processors are further operable to:
generate a verified user profile; and
in the event the total verification score for the potential investor exceeds the pre-defined total verification score threshold, the one or more processors are further operable to:
generate a verified potential investor profile; and
compare, the investment opportunity associated with the verified profile of the user with the verified potential investor profile in an attempt to establish a match between the investment opportunity and the potential investor.

2. The computer-implemented system of claim 1, wherein the verification process regarding the user comprising the one or more processors interrogating publicly available information across a data communications network.

3. The computer-implemented system of claim 1, wherein the verification process regarding the potential investor comprises the one or more processors interrogating one or more financial data sources operably connected to the data communications network.

4. The computer-implemented system of claim 1, wherein the verification process regarding the user or the potential investor utilises one or more artificial intelligence techniques.

5. The computer-implemented system of claim 1, where in the verification process regarding the user or the potential investor utilises one or more character recognition techniques or scraping recognition technology.

6. The computer-implemented system of claim 1, wherein the verification process regarding the potential investor comprises obtaining an estimate regarding a private wealth profile of the investor obtained from digital information regarding the investor.

7. The computer-implemented system of claim 1, wherein the user having an investment opportunity is required to meet a minimum standard of disclosure regarding the investment opportunity to generate an investment opportunity profile having minimum requirements comprising any one or more of an executive summary, an overview of the market, revenue profile, expenditure, marketing estimates, personal profiles of the individuals operating the business and expected investment funds required to achieve objectives detailed in the executive summary.

8. The computer-implemented system of claim 1, wherein the verification process to generate verified user profiles and verified potential investor profiles is supported by additional analysis of external data obtained from data sources accessible and operably connected to the internet.

9. The computer-implemented system of claim 1, wherein the one or more processors are operable to continuously review and analyse investment opportunities associated with verified user profiles and also continuously review and analyse verified investor profiles to identify and propose potential matches that achieve, or exceed, a pre-defined threshold match between investment opportunities and investors wherein the continuous and ongoing identification of matching investment opportunities and investors is conducted automatically.

10. A computer-implemented method for facilitating a connection between a user having one or more investment opportunities and one or more potential investors to enable communication therebetween, the method comprising:
receiving and recording, by one or more processors, details from a user seeking to register an investment opportunity, the details comprising at least a description of the goods and/or services provided, or that are to be provided, by a business associated with the investment opportunity;
receiving and recording, by the one or more processors, information from a potential investor;
verifying, by the one or more processors performing a verification process, whether the user and the potential investor each has the necessary bona fides to represent their interest in the investment opportunity, the verification process requiring:
the user and the potential investor to each upload an identity document and a real-time response to a randomized prompt; and
the potential investor to also provide proof that they are able to commit funds that exceed a pre-defined minimum threshold, wherein the verification process further comprises:
determining, by the one or more processors, a total verification score for the user, wherein the total verification score for the user is based at least on the following predefined criteria:
an identity criterion;
a liveliness criterion and
a cross-reference criterion; and
determining, by the one or more processors, a total verification score for the potential investor, wherein the total verification score for the potential investor is based at least on the following pre-defined criteria:
an identity criterion;
a liveliness criterion and
a proof of funds criterion;
wherein:
in the event the total verification score for the user exceeds a pre-defined total verification score threshold, generating, by the one or more processors, a verified user profile; and
in the event the total verification score for the potential investor exceeds the pre-defined total verification score threshold, generating, by the one or more processors, a verified potential investor profile; and
comparing the investment opportunity associated with the verified profile of the user with the verified potential investor profile in an attempt to establish a match between the investment opportunity and the potential investor.

11. The computer-implemented method of claim 10, wherein the verification process regarding the user comprises interrogation of publicly available information across a data communications network.

12. The computer-implemented method of claim 10, wherein the verification process regarding the potential investor comprises interrogation of one or more financial data sources operably connected to the data communications network.

13. The computer-implemented method of claim 10, wherein the verification process regarding the user or the potential investor utilises one or more artificial intelligence techniques.

14. The computer-implemented method of claim 10, wherein the verification process regarding the user or the potential investor utilises one or more character recognition techniques or scraping technology.

15. The computer-implemented method of claim 10, wherein the verification process regarding the potential investor comprises obtaining an estimate regarding a private wealth profile of the investor obtained from digital information regarding the investor.

16. The computer-implemented method of claim 10, wherein the user, having an investment opportunity, is required to meet a minimum standard of disclosure regarding the investment opportunity to generate an investment opportunity profile having various minimum requirements comprising any one or more of an executive summary, an overview of the market, revenue profile, expenditure, marketing estimates, personal profiles of the individuals operating the business and expected investment funds required to achieve objectives detailed in the executive summary.

17. The computer-implemented method of claim 10, further comprising conducting, by the one or more processors, a detailed analysis of investment opportunities to identify one or more factors comprising strengths, weaknesses, opportunities and threats according to a range of considerations comprising any one or more of barriers to market entry, investment requirements, estimated time to achieve return on investment, the quantum of return, the number of employees required, overview of business sector according to previous profits and geographical region, uniqueness of the investment opportunity, potential legal issues, estimated growth of investment and estimated return over pre-defined periods of time.

18. The computer-implemented method of claim 10, wherein generating verified user profile and verified potential investor profiles is supported by additional analysis of external data obtained from data sources accessible and operably connected to the data communications network.

19. The computer-implemented method of claim 10, further comprising continuously reviewing and analysing investment opportunities associated with verified user profiles and verified investor profiles, by the one or more processors, to identify and propose potential matches that achieve or exceed a pre-defined threshold match between investment opportunities and investors wherein the continuous and ongoing identification of matching investment opportunities and investors is conducted automatically.

20. A computer-readable medium having a plurality of stored executable instructions thereon that, when executed, cause one or more processors to perform the steps of:
receiving and recording details from a user seeking to register an investment opportunity, the details comprising at least a description of the goods and/or services provided, or that are to be provided, by a business associated with the investment opportunity;
receiving and recording information from a potential investor;
verifying, by the one or more processors performing a verification process, whether the user and potential investor each have the necessary bona fides to represent their interest in the investment opportunity, the verification process requiring;
the user and the potential investor to each upload an identity document and a real-time response to a randomized prompt; and
the potential investor to also provide proof that they are able to commit funds that exceed a pre-defined minimum threshold, wherein the verification process further comprises:
determining, by the one or more processors, a total verification score for the user, wherein the total verification score for the user is based at least on the following predefined criteria:
an identity criterion;
a liveliness criterion and
a cross-reference criterion; and
determining, by the one or more processors, a total verification score for the potential investor, wherein the total verification score for the potential investor is based at least on the following pre-defined criteria:
an identity criterion;
a liveliness criterion and
a proof of funds criterion;
wherein:
in the event the total verification score for the user exceeds a pre-defined total verification score threshold, generating, by the one or more processors, a verified user profile; and
in the event the total verification score for the potential investor exceeds the pre-defined total verification score threshold, generating, by the one or more processors, a verified potential investor profile; and
comparing, by the one or more processors, the investment opportunity associated with the verified profile of the user with the verified potential investor profile in an attempt to establish a match between the investment opportunity and the potential investor.
